(19) United States
(12) Patent Application Publication
(10) Pub. No.: US 2017/0074121 A1
(43) Pub. Date: Mar. 16, 2017

(54) COOLANT ENERGY AND EXHAUST ENERGY RECOVERY SYSTEM

(71) Applicant: EATON CORPORATION, Cleveland, OH (US)

(72) Inventors: Swaminathan SUBRAMANIAN, Farmington Hills, MI (US); Karen BEVAN, Northville, MI (US); Mihai DOROBANTU, Richland, MI (US)

(73) Assignee: EATON CORPORATION, Cleveland, OH (US)

(21) Appl. No.: 15/122,788

(22) PCT Filed: Mar. 3, 2015
(86) PCT No.: PCT/US15/18372

§ 371 Date: Aug. 31, 2016

Related U.S. Application Data
(60) Provisional application No. 61/947,389, filed on Mar. 3, 2014.
(60) Provisional application No. 62/065,433, filed on Oct. 17, 2014.
(60) Provisional application No. 62/081,514, filed on Nov. 18, 2014.
(60) Provisional application No. 62/116,844, filed on Feb. 16, 2015.

(51) Int. Cl. F01K 23/06; F02M 26/30; F01P 5/10; F04C 2/12; F01P 3/20

(52) U.S. Cl. CPC F01K 23/065; F04C 2/126; F01P 3/20; F01P 5/10; F02M 26/30

(57) ABSTRACT

The present teachings include a power generation system for recovering waste heat energy from a power plant having a coolant circuit that extends through the power plant. The coolant circuit may also include a radiator and a coolant pump configured to circulate the coolant between the internal combustion engine and the radiator. The power generation system may also include a waste heat recovery circuit including a Roots-type fluid expander configured to generate power at an output shaft by expanding a portion of the coolant and being configured to deliver the power back to the internal combustion engine crankshaft via the output shaft. The waste heat recovery circuit may further include a circulation pump configured to circulate coolant between the Roots-type expander and the coolant circuit. A condenser may also be provided to condense the coolant leaving the Roots-type fluid expander at least down to a saturated liquid.

### PRIORITY CLAIM

This application is being filed on Mar. 3, 2015, as a PCT International Patent application and claims priority to U.S. Patent Application Ser. No. 61/947,389 filed on Mar. 3, 2014; U.S. Patent Application Ser. No. 62/065,433 filed on Oct. 7, 2014; U.S. Patent Application Ser. No. 62/081,514 filed on Nov. 18, 2014; and U.S. Patent Application No. 62/116,844 filed on Feb. 16, 2015, the disclosures of which are incorporated herein by reference in their entireties.

### TECHNICAL FIELD

The present disclosure relates to systems for recovering waste heat. More particularly, the present disclosure relates to waste heat energy recovery from the exhaust and coolant circuit of a power plant with an expansion device, such as a Roots-type expander.

### BACKGROUND

Waste heat energy is necessarily produced in many processes that generate energy or convert energy into useful work, such as a power plant. Typically, such waste heat energy is released into the ambient environment. In one application, waste heat energy is generated from an internal combustion engine. Exhaust gases from the engine have a high temperature and pressure and are typically discharged into the ambient environment without any energy recovery process. Additional waste energy is developed within the power plant which is typically discharged via a radiator without any energy recovery. Although some approaches have been introduced to recover waste energy and re-use the recovered energy in the same process or in separate processes, there is still demand for enhancing the efficiency of energy recovery in power generation systems, such as vehicle engines or electrical generators.

### SUMMARY

The present teachings include a power generation system for recovering waste heat energy from a power plant. In one aspect, the power plant may be configured as an internal combustion engine having a crankshaft. A coolant circuit may also be provided that extends through the internal combustion engine, wherein the coolant circuit may include a radiator and a coolant pump configured to circulate the coolant between the internal combustion engine and the radiator. The power generation system may also include a waste heat recovery circuit including an expansion device, such as a Roots-type fluid expander, configured to generate power at an output shaft by expanding a portion of the coolant and being configured to deliver the power back to the internal combustion engine crankshaft via the output shaft. The waste heat recovery circuit may also include a circulation pump configured to circulate the portion of the coolant between the expander and the coolant circuit. A condenser may also be provided to condense the portion of the coolant leaving the expander at least down to a saturated liquid.

In one example, the waste heat recovery circuit can be configured such that the circulation pump draws the portion of the coolant after the portion of the coolant has first passed through the internal combustion engine and returns the portion of the coolant at a location upstream of the radiator. In one example, the waste heat recovery circuit can be configured such that the circulation pump draws the portion of the coolant before the portion of the coolant has first passed through the internal combustion engine and returns the portion of the coolant at a location upstream of the radiator. The waste heat recovery circuit may also include additional heat sources, such as an EGR cooler and a post-turbine exhaust recovery system

The present teachings also include a method of recovering waste heat from a power plant. The method can include the steps of providing a liquid cooled power plant having a crankshaft, pumping a coolant with a fluid pump through a coolant circuit including the power plant, drawing a portion of the coolant from coolant circuit, heating the portion of the coolant with heat generated by the power plant, expanding the portion of the coolant with an expansion device, such as a Roots-type fluid expander, such that power is generated at an output shaft of the expander, delivering the power developed at the expander output shaft to the internal combustion engine crankshaft, condensing the coolant to at least a saturated liquid state, and returning the portion of the coolant to the coolant circuit.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

Non-limiting and non-exhaustive embodiments are described with reference to the following figures, which are not necessarily drawn to scale, wherein like reference numerals refer to like parts throughout the various views unless otherwise specified.

FIG. 1 is a schematic view of a vehicle having a power generation system having features that are examples of aspects in accordance with the principles of the present disclosure.

FIG. 2 is a schematic view of a electrical generation system having a power generation system having features that are examples of aspects in accordance with the principles of the present disclosure.

FIG. 3 is a schematic view of the power generation system shown in FIGS. 1 and 2.

FIG. 4 is a process flow chart showing an example operation of the power generation system shown in FIG. 3.

FIG. 5 is a schematic view of the power generation system shown in FIG. 3 showing further details of the system.

FIG. 6 shows the power generation system shown in FIG. 5 arranged in a first architecture.

FIG. 7 shows the power generation system shown in FIG. 5 arranged in a second architecture.

FIG. 8 shows the power generation system shown in FIG. 5 arranged in a third architecture.

FIG. 9 shows the power generation system shown in FIG. 5 arranged in a fourth architecture.

FIG. 10 shows the power generation system shown in FIG. 5 arranged in a fifth architecture.

FIG. 11 shows the power generation system shown in FIG. 5 arranged in a sixth architecture.

FIG. 12 shows the power generation system shown in FIG. 5 arranged in a seventh architecture.

FIG. 13 shows the power generation system shown in FIG. 5 arranged in an eighth architecture.

FIG. 14 shows the power generation system shown in FIG. 5 arranged in a ninth architecture.

FIG. 15 shows the power generation system shown in FIG. 5 arranged in a tenth architecture.

FIG. 16 shows the power generation system shown in FIG. 5 arranged in an eleventh architecture.

FIG. 17 shows the power generation system shown in FIG. 5 arranged in a twelfth architecture.

FIG. 18 is a schematic view of a variation of the power generation system architecture shown in FIG. 5 in an optional operational configuration.

FIG. 19 is a schematic view of the variation of the power generation system architecture shown in FIG. 18 in an optional operational configuration.

FIG. 20 is a schematic view of a variation of the power generation system architecture shown in FIG. 5 in an optional operational configuration.

FIG. 21 is a schematic view of a variation of the power generation system architecture shown in FIG. 5 in an optional operational configuration.

FIG. 22 is a schematic view of a variation of the power generation system architecture shown in FIG. 5 in an optional operational configuration.

FIG. 23 is a schematic view of the variation of the power generation system architecture shown in FIG. 22 in an optional operational configuration.

FIG. 24 is a schematic view of the variation of the power generation system architecture shown in FIG. 22 in an optional operational configuration.

FIG. 25 is a schematic view of a variation of the power generation system architecture shown in FIG. 5 in an optional operational configuration.

FIG. 26 is a schematic view of a variation of the power generation system architecture shown in FIG. 5 in an optional operational configuration.

FIG. 27 is a schematic view of the variation of the power generation system architecture shown in FIG. 26 in an optional operational configuration.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

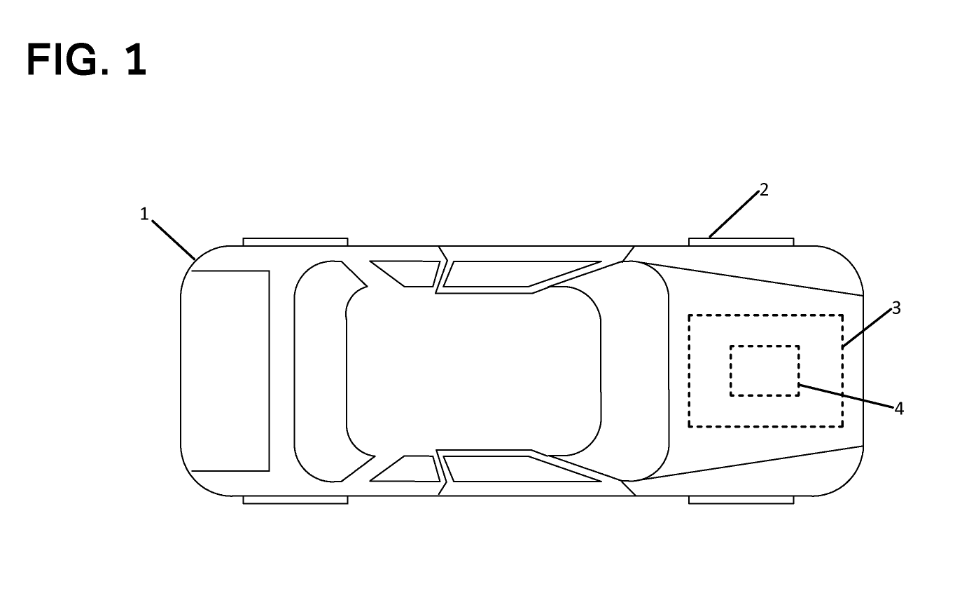

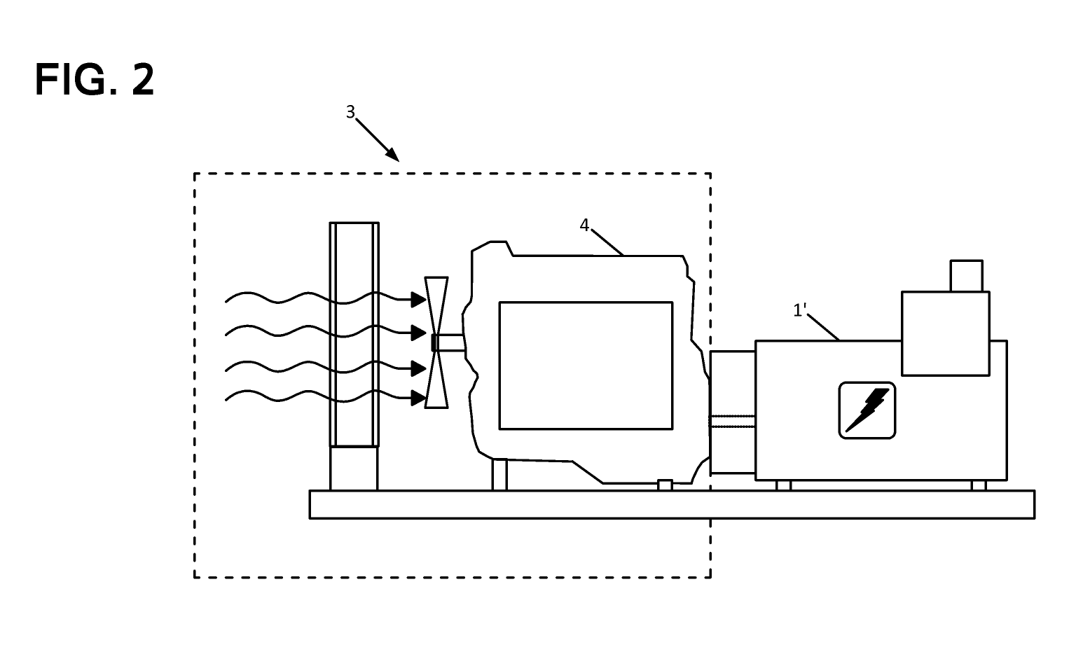

Referring to FIG. 1, a vehicle 1 is shown having wheels 2 for movement along an appropriate road surface. The vehicle 1 includes a power generation system 3 including a power plant 4 that provides power to the vehicle 1. The power generation system 3 can also be provided as part of an electrical generator system, wherein the power plant 4 provides power to an electrical generator 1, as shown in FIG. 2.

The power plant 4 can be configured to employ a power-generation cycle, wherein the power plant 4 uses a specified amount of oxygen, which may be part of a stream of intake air, to generate power. The power plant 4 also generates waste heat such in the form of a high-temperature exhaust gas which is a byproduct of the power-generation cycle. The power plant also generates additional waste heat which is rejected through a radiator via a coolant. The coolant may be water or another fluid, or a mixture of water and another fluid, such as propylene glycol, ethylene glycol, and ethanol. In one example, the coolant is a mixture of 50 percent water and 50 percent glycol. In one embodiment, the power plant 4 is an internal combustion (IC) engine, such as a spark-ignition or compression-ignition type (i.e. diesel engine) which combusts a mixture of fuel and air to generate power. In one embodiment, the power plant 4 may be or a fuel cell which converts chemical energy from a fuel into electricity through a chemical reaction with oxygen or another oxidizing agent. Where the power plant 4 is located within a vehicle 1, additional waste heat energy is produced when a compression release engine brake (i.e. Jake brake or Jacobs brake) system is utilized. In such a system, significant heat energy in the form of compressed air is produced and discharged through the exhaust.

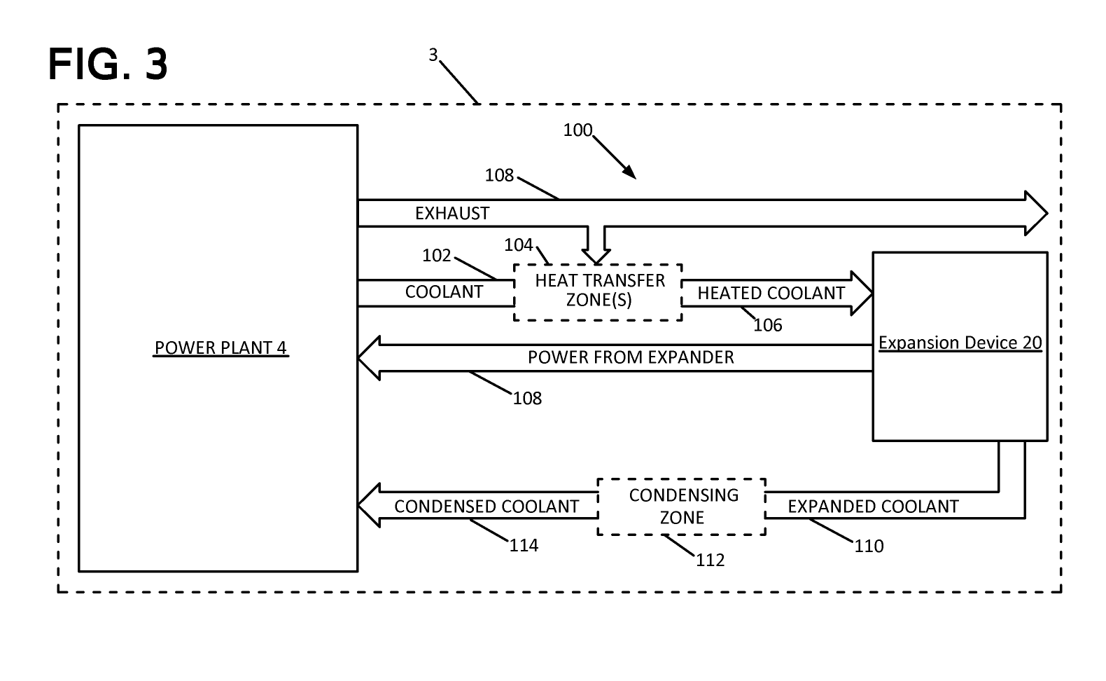

Referring to FIG. 3, a schematic is provided showing the general principal of operation of the power generation system 3, which includes a waste heat recovery circuit (WHRC) 100. The WHRC 100 is configured to capture heat energy from the exhaust and coolant while utilizing the coolant itself as a working fluid. The WHRC 100 is also configured to generate power from the recovered waste heat energy returns that power back to the power plant 4. As such, the waste heat recovery circuit 100 operates to increase the overall operating efficiency of the power plant 4.

In one aspect, the WHRC 100 can include an expansion device 20 to transform the heat energy in the coolant to power that can be transferred back to the power plant 4. Types of expansion devices 20 usable with WAHRC 100 are non-volumetric expanders, such as screw and scroll-type expanders 20, and volumetric expanders, such as Roots-type expanders 20. Roots-type expanders 20 useful for use with the concepts disclosed herein are fully described in Patent Cooperation Treaty (PCT) international Application Publication Number WO 2013/30774; Patent Cooperation Treaty (PCT) International Application Publication Number WO 2014/117159; and Indian Provisional Application No. 4024/DEL/2014, filed Dec. 30, 2014 and entitled OPTIMAL EXPANDER OUTLET PORTING, the entireties of which are incorporated herein by reference. As used herein, the term “Roots-type expander” is intended to mean a volumetric or positive displacement fluid expansion device provided with a pair of intermeshed, non-contacting helical rotors that rotate synchronously in opposite directions such that a working fluid passing there through undergoes a pressure drop which imparts rotational movement onto the rotors, thus creating mechanical work at an output shaft 21. As described in WO 2014/117159, the Roots-type expander may have one or more pairs of rotors 30, 32 for single stage or multiple stage operation in which the working fluid is sequentially routed from one stage to the next.

Roots-type expanders 20 are advantageous for use with some of the architectures disclosed below because they remain fully operable with either single phase or two-phase working fluid flow. As such, the entering heated coolant can have a vapor quality (i.e. mass fraction of coolant that is a vapor) of anywhere between 0% to 100% (i.e. between being in a fully liquid state to being superheated) without adversely affecting the expander 20. In fact, the efficiency of the expander 20 can be expected to increase where two-phase flow is present, as the liquid portion of the flow acts to seal the necessary clearance gaps between the rotors and the housing within which the rotors are disposed.

Still referring to FIG. 3, the WHRC 100 draws or extracts a coolant stream 102 from the coolant circuit of the power plant 4. In one example, the coolant stream 102 represents a fraction of the total coolant flow within the power plant coolant circuit. The coolant stream 102 may then heated by one or more heat transfer zones 104 to form a heated coolant stream 106. The heat transfer zones 104 may each include one or more individual heat exchanger(s) which may be in fluid communication with a portion of the exhaust gas flow 108 from the power plant 4 or may connect with any other available heat source. Non-limiting examples of suitable heat exchangers are exhaust gas recirculation (EGR) coolers 10, post-turbine exhaust boilers 11, charge air coolers 12, recuperators 24, exhaust manifold coolers 25, exhaust gas heat exchangers 26, and any other type of heat exchanger that is adapted to transfer heat energy from the power plant 4 or vehicle 1 to a liquid coolant. In some examples, multiple heat exchangers in the heat transfer zone 104 are used in series to heat the coolant 102 in stages. It is also noted that, in some applications, the coolant stream 102 from power plant 4 may be directly provided to the expansion device 20, wherein no heat exchangers or heat transfer zone 104 are utilized. In either case, once the coolant is delivered to the expansion device 20, the coolant is expanded to have a lower pressure and temperature, thereby generating power or useful work 108 that can be delivered back to the power plant 4.

After leaving the expansion device 20, the expanded coolant 110 is then condensed in a cooling zone 112 to at least a saturated liquid state to form a condensed coolant 114. The cooling zone 112 for condensing the expanded coolant 110 can take a variety of forms, as explained herein. For example, the expanded coolant 110 can be condensed by reintroducing the expanded coolant 110 into the main coolant flow stream. This approach is most valuable when the expanded coolant 110 flow is a relatively small fraction of the total coolant flow through the power plant 4. The expanded coolant 110 can also be condensed by passing the expanded coolant 110 through an air cooled condenser or by passing the expanded coolant 110 through a liquid cooled recuperator. Where an air cooled condenser is used, the air through the condenser can be provided by a cooling fan of the power plant 4. Where a recuperator is used, the coolant stream 102 can be used to provide a cooling flow stream to the recuperator. Other means for condensing the expanded coolant 110 may also be utilized.

This general process is shown in the flow chart at FIG. 3, wherein a process 1000 is presented in which an expansion device in fluid communication with a coolant of a liquid cooled power plant is provided in a step 1002. In a step 1004, heat energy is transferred from the power plant to the coolant to develop a heated coolant. In a step 1006, the heated coolant is passed through the expansion device to develop an expanded coolant such that power is developed at an output shaft of the expander. In a step 1008, the power developed at the expander is transferred either directly or indirectly back to the power plant while in a step 1010 the expanded coolant is condensed back into at least a saturated liquid.

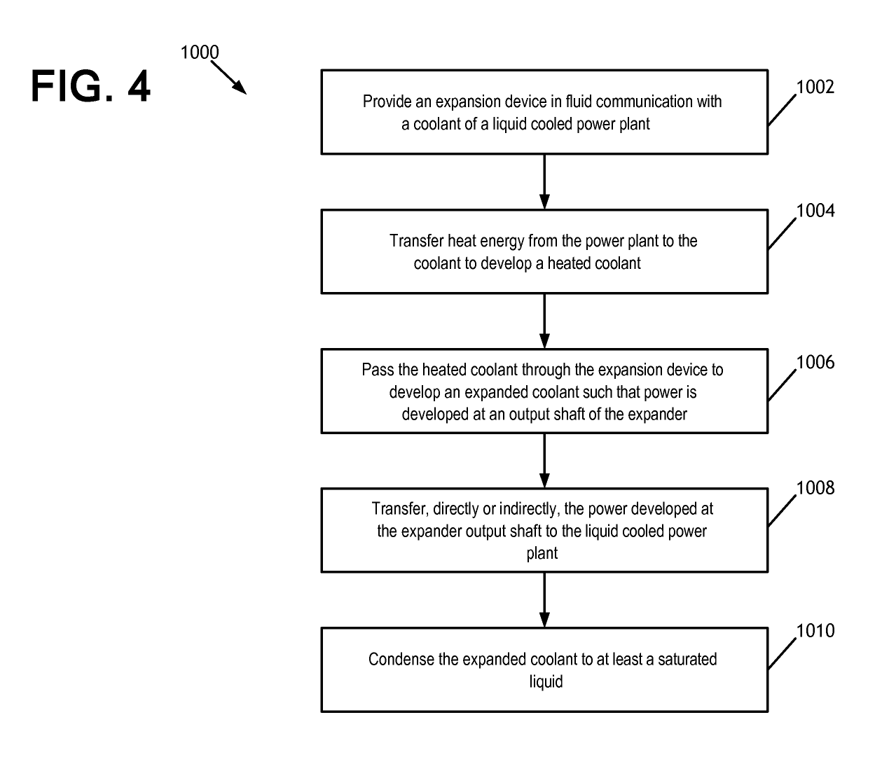

With reference to FIG. 4, a general system architecture model is presented for the power generation system 3. As shown, the system 3 includes an internal combustion engine 4 having an output shaft 5 for delivering power developed by the internal combustion 4 to, for example, wheels 2 or a generator. The internal combustion engine further includes an air intake 6 and an exhaust outlet 7 along with a cooling inlet 8 and a cooling outlet 9. In operation, air enters the air intake 6 and combines with fuel for combustion, the byproducts of which are exhausted through outlet 7.

As presented, the power plant 4 is liquid cooled by a coolant circuit. As such, a coolant passes through the power plant 4 via an inlet 8 and an outlet 9, and then flows to a radiator 13. Where the power plant 4 is an internal combustion engine, the coolant flows through and maintains the temperature of the engine block of the engine. A fan 14, driven by the power plant 4, may be provided to draw air through the radiator 13 such that the temperature of the coolant is reduced as it flows through the radiator 13. The fan 14 may be mechanically driven through crankshaft 5 or a hydraulic circuit, or may be driven with an electric motor. The coolant flow through the radiator 13 is controlled by a coolant pump 15 and a thermostat 16. In one example, the thermostat 16 is configured to open at a coolant temperature of 90° C. An expansion tank 17 may also be provided in the coolant circuit.

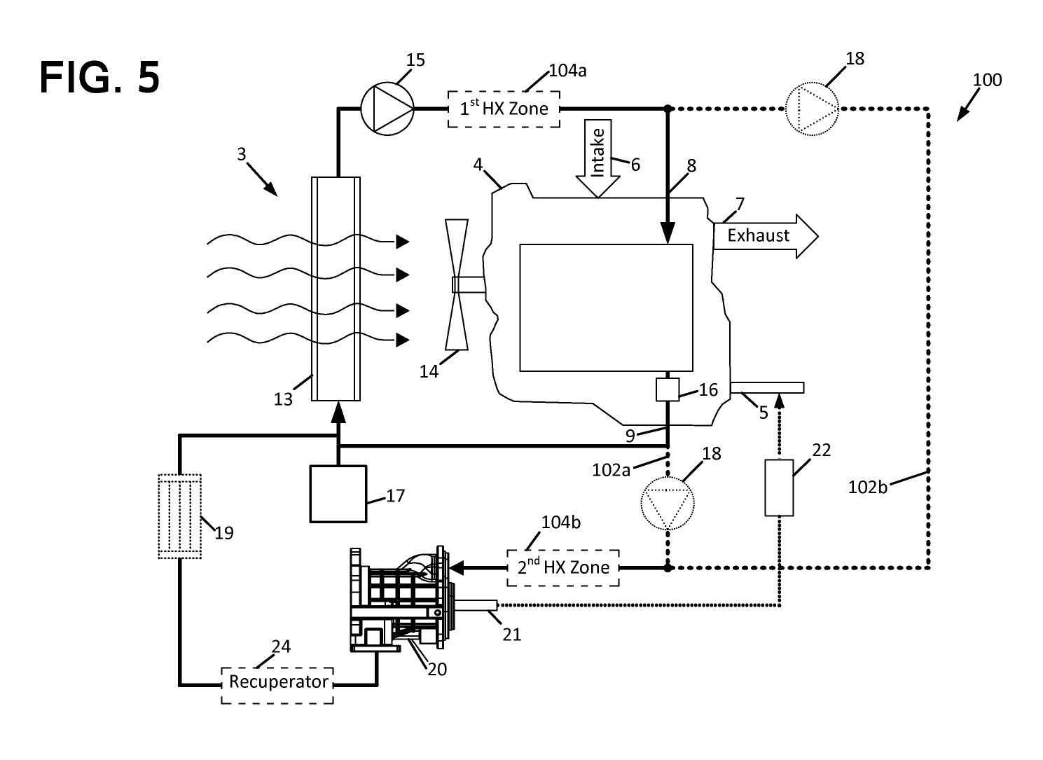

As described previously, the power generation system 3 may also include the WHRC 100 which may include an expansion device 20 in fluid communication with the coolant circuit 102. In one architecture option, a circuit 102a may be utilized in which a portion of the coolant is directed towards the expansion device 20 at a location downstream of the power plant 4. In this configuration, the coolant that is ultimately delivered to the expansion device 20 is first heated by the power plant 4 itself. In an alternative architecture option, a circuit 102b may be utilized in which a portion of the coolant is directed towards the expansion device 20 at a location upstream of the power plant 4. In this configuration, the coolant that is ultimately delivered to the expansion device 20 bypasses the power plant 4 and is therefore not first heated by the power plant 4. Although it is conceivable that circuits 102a and 102b could be used together in some configurations, FIG. 5 contemplates configurations in which circuit 102a is used at the exclusion of FIG. 102b, and vice versa.

As shown, two distinct heat exchanging zones 104a and 104b are presented in the schematic shown at FIG. 5. The first heat exchanging zone 104a is located between the circulation pump 14 and the intake 8 of the power plant 4. As such, all of the coolant that is circulated through the power plant 4 is circulated through the first heat exchanging zone 104a. The second heat exchanging zone 104b is located in the circuit 102a upstream of the expansion device 20. As such, only a portion of the coolant that is circulated through the power plant 4 is circulated through the second heat exchanging zone 104b. Regardless of whether circuit 102a or 102b is utilized, WHRC 100 may include one or both of the first and second heat exchanging zones 104a, 104b.

With continued reference to FIG. 5, either of the circuits 102a, 102b may be provided with a circulation pump 18 for circulating a portion of the total coolant flow through the heat exchanging zones 104 and the expansion device 20. In one example, the circulation pump 18 is located downstream of the thermostat 16. A condenser 19 may also be provided downstream of the expansion device 20 to ensure that the expanded coolant is condensed to a saturated liquid state. Where used, the condenser 19 can use coolant leaving the radiator 13 and upstream of the power plant 4 intake 8 as the cooling source for cooling the expanded coolant. In some applications, it is desirable to provide a pump (not shown) downstream of the condenser 19 when the resulting pressure after condensation is sufficiently low to require an additional pressure source for recombination with the coolant not delivered to the WHRC 100 and subsequent delivery to the radiator 13.

As will be appreciated from the disclosures herein, the portion of coolant that passes through the expansion device 20 is essentially subjected to a Rankine cycle in which the power plant 4 and/or the heat exchanging zone(s) 104 (104a, 104b) heat the coolant; the circulation pumps 15, 23 act as the pressure source; the expansion device 20 acts as the expansion source; and the condenser 19, the radiator 13, and/or the main coolant flow, act as the sources of temperature reduction to ensure the coolant is returned to a saturated liquid. Thus, as the coolant passes through the expander 20, the coolant undergoes expansion and a corresponding temperature and pressure drop to generate power or useful work at shaft 21.

In one aspect, the fluid expansion device 20 may also include a power transmission link 22 configured to transfer useful work from the fluid expansion device 20. Such mechanical work generated by the rotation of the output shaft 21 of the fluid expansion device 20 may be delivered to any elements or devices as necessary. For example, the output shaft 21 can be directly or indirectly coupled to the power plant 4, another fluid expansion device, a turbocharger, a supercharger, a generator, a motor, a hydraulic pump, and/or a pneumatic pump via gears, belts, chains or other structures. In some examples, the recuperated energy may be accumulated in an energy storage device, such as a battery or an accumulator, and the energy storage device may release the stored energy on demand. In other examples, the recovered energy may return to the power plant 4 by mechanically coupling the output shaft of the device 21 to the crankshaft 5 or any other power input location of the power plant 4. The power transmission link 22 may also be employed between the volumetric fluid expander 20 and the power plant 4 to provide a better match between rotational speeds of the power plant 4 and the output shaft 21 of the expander 20. In some embodiments, the power transmission link 22 can be configured as a planetary gear set to provide two outputs for the power plant 4 and a generator.

As mentioned previously, the heat exchanging zone 104 may include one or more zones (e.g 104a, 104b) and each of the zones may include one or more heat sources or heat exchangers to heat the coolant prior to entering the expansion device 20. One example of a suitable heat exchanger is a charge air cooler 12 which utilizes the coolant to cool the intake air after being compressed, for example by a supercharger or a turbocharger. Another example of a suitable heat exchanger is an exhaust gas recovery (EGR) cooler 10 which utilizes the coolant to cool a portion of the exhaust gases before reintroduction into the intake air. Yet another example is an exhaust heat exchanger 26 in which the coolant can be utilized to absorb heat energy directly from the power plant exhaust. A post-turbine boiler 11 may also be utilized in which heat energy is captured by the coolant from an exhaust stream leaving a turbocharger.

Also, a heat exchanger in the form of a recuperator 24 may also be used. In such an application, the recuperator 24 can be located downstream of the expansion device 20 and can act to transfer heat from the expanded to coolant to either of the first and second heat exchanging zones 104a, 104b. Where used, the recuperator 24 will act to cool the expanded coolant and can be sized such that a condenser 19 does not also need to be placed in the system or can be sized to work in conjunction with a condenser 19. The recuperator 24 allows for some of the remaining heat energy in the coolant leaving the expander 20 to be recaptured rather than being lost in the condenser 19 and/or being dissipated through the radiator 13.

Another example of a heat exchanger is an exhaust manifold cooler 25 which utilizes the coolant to cool the exhaust gases leaving the exhaust manifold. An exhaust manifold cooler is useful in applications where the leaving exhaust gas temperature from the power plant 4 exceeds temperature limits of downstream components, for example turbochargers and emissions components. Recent demands for performance improvements of internal combustion engines have resulted in smaller displacement engines producing exhaust at relatively high temperatures, for example temperatures of 1000° C. or more. As emissions components (e.g. catalysts) and turbochargers require significantly lower temperatures, for example temperatures below 700° C., an exhaust manifold cooler can be provided to address this circumstance. As mentioned previously, although several types of heat exchangers are discussed in the previous paragraphs, other heat exchangers may be used without departing from the concepts herein, including those heat exchangers transfer heat to the coolant from sources outside of the power plant 4.

Myriad possible arrangements exist when applying the above identified heat exchangers to the various optional architectures shown in FIG. 5. As such, Table 1 is provided below to present specific architectures so that further concepts of the disclosure may be discussed in further detail. It is noted that the disclosed concepts are not limited to the architectures presented in Table 1. For each of Architectures identified below, it is noted that the condensing zone 112 can include any one or more of the above noted implementations of a condenser, recuperator, or mixing (of the expanded coolant into the main coolant flow), unless otherwise noted specifically. In Table 1, the following abbreviations are used: Charge Air Cooler=CAC, Exhaust Recovery=ER, EGR Cooler=EGRC, Post-Turbine Exhaust Recovery−PTER, Exhaust Manifold Cooler=EMC, Recuperator=RECUP. Where a “→” symbol is used, it is meant to indicate sequential flow from one heat exchanger to another heat exchanger.

TABLE 1

| | Cir- | 1^{st} | 2^{nd} | Pump |
|---|---|---|---|---|
| Architecture | cuit | HX Zone | HX Zone | 18 |
| Architecture | 102a | CAC | ER | Yes |
| 1 | | | | |
| Architecture | 102a | EGRC | — | Yes |
| 2 | | | | |
| Architecture | 102a | EGRC | ER | Yes |
| 3 | | | | |
| Architecture | 102a | CAC | EGRC | No |
| 4 | | | | |
| Architecture | 102a | CAC | PTER | No |
| 5 | | | | |
| Architecture | 102a | CAC → | PTER | No |
| 6 | | EGRC | | |
| Architecture | 102b | — | CAC →EMC → | No |
| 7 | | | PTER → EGRC | |
| Architecture | 102b | — | EGRC →EMC | No |
| 8 | | | | |
| Architecture | 102b | — | EGRC →EMC → | No |
| 9 | | | PTER | |
| Architecture | 102b | — | CAC →EMC → | Yes |
| 10 | | | PTER → EGRC | |
| Architecture | 102b | — | EGRC →EMC | Yes |
| 11 | | | | |
| Architecture | 102b | — | EGRC →EMC | Yes |
| 12 | | | → PTER | |
| Architecture | 102a | EGRC → | — | Yes |
| 13 | | PTER | | |
| Architecture | 102a | EGRC | — | Yes |
| 14 | | | | |
| Architecture | 102b | — | EGRC → | Yes |
| 15 | | | PTER | |
| Architecture | 102b | EGRC | — | Yes |
| 16 | | | | |
| Architecture | 102a | RECUP → | — | Yes |
| 17 | | EGRC → | | |
| | | PTER | | |
| Architecture | 102b | EGRC → | — | Yes |
| 18 | | RECUP → | | |
| | | PTER | | |
| Architecture | 102a | EGRC → | — | Yes |
| 19 | | ER | | |
| Architecture | 102a | EMC → | — | Yes |
| 20 | | EGRC → | | |
| | | ER | | |
| Architecture | 102b | EGRC → | — | Yes |
| 21 | | ER | | |
| Architecture | 102b | EMC → | — | Yes |
| 22 | | EGRC → | | |
| | | ER | | |

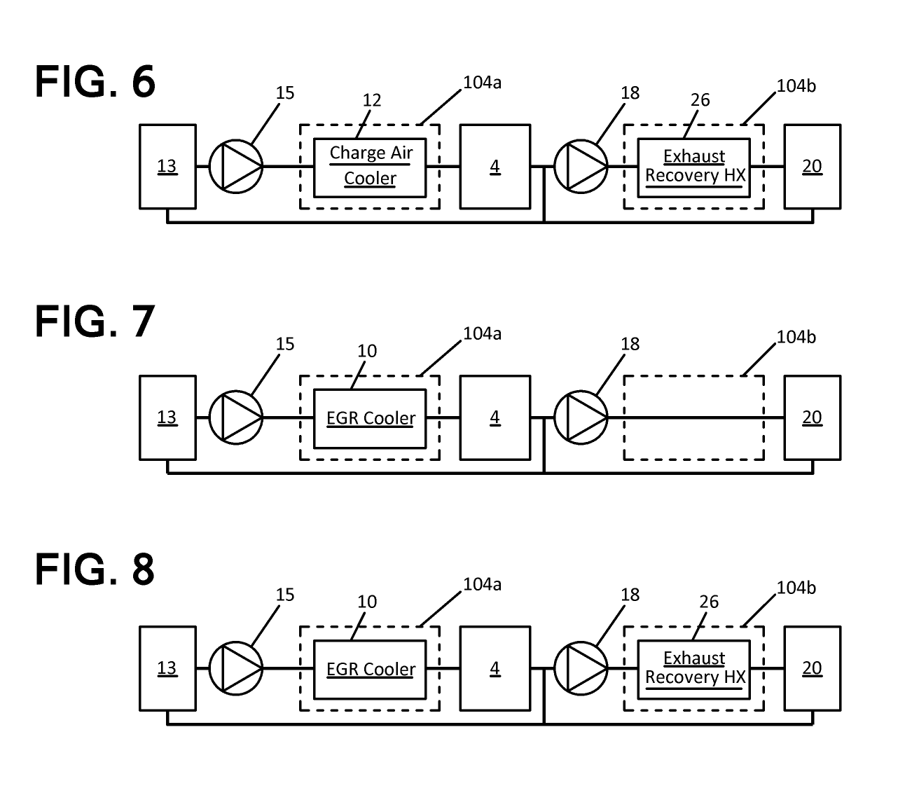

It is noted that Architectures 7-9 may be particularly suited to applications where a vehicle 1 is a passenger car and the power plant utilized gasoline as the fuel. Architectures 19 and 21 may be best suited for heavy duty applications while Architectures 20 and 22 may be best suited for medium duty applications involving diesel power plants. FIG. 6-17 provide a further illustration of Architectures 1-12 identified above. Each of these figures is discussed in the following paragraphs.

FIG. 6 illustrates Architecture 1, wherein the first heat exchanging zone 104a includes a charge air cooler 12 and the second heat exchanging zone 104b includes an exhaust recovery heat exchanger 26, and wherein circulation pump 18 is provided to circulate coolant through the exhaust recovery heat exchanger and the expander 20.

FIG. 7 illustrates Architecture 2, wherein the first heat exchanging zone 104a includes an EGR cooler 10 and the second heat exchanging zone 104b does not include any heat exchanger, and wherein circulation pump 18 is provided to circulate coolant through the expander 20.

FIG. 8 illustrates Architecture 3, wherein the first heat exchanging zone 104a includes an EGR cooler 10 and the second heat exchanging zone 104b includes an exhaust recovery heat exchanger 26, and wherein circulation pump 18 is provided to circulate coolant through the exhaust recovery heat exchanger and the expander 20.

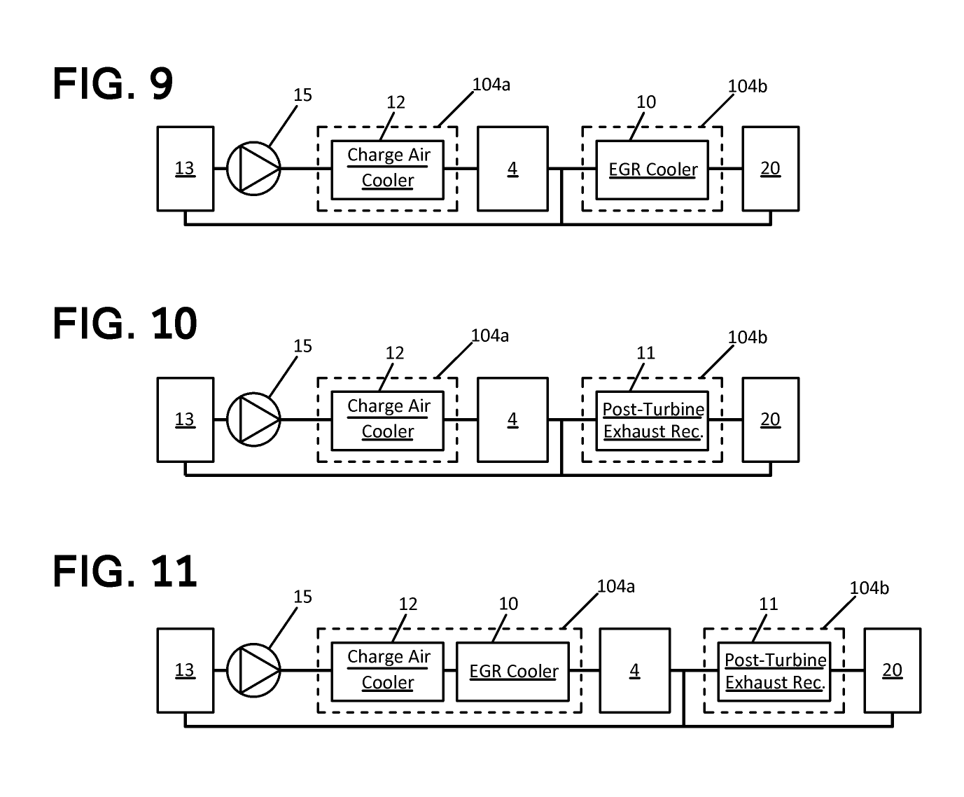

FIG. 9 illustrates Architecture 4, wherein the first heat exchanging zone 104a includes a charge air cooler 12 and the second heat exchanging zone 104b includes an EGR cooler 10, and wherein circulation pump 15 provide all necessary system flow, including flow through the expander 20.

FIG. 10 illustrates Architecture 5, wherein the first heat exchanging zone 104a includes a charge air cooler 12 and the second heat exchanging zone 104b includes a post-turbine exhaust boiler 11, and wherein circulation pump 15 provide all necessary system flow, including flow through the expander 20.

FIG. 11 illustrates Architecture 6, wherein the first heat exchanging zone 104a includes a charge air cooler 12 and an EGR cooler 10, wherein the second heat exchanging zone 104b includes a post-turbine exhaust boiler 11, and wherein circulation pump 15 provide all necessary system flow, including flow through the expander 20.

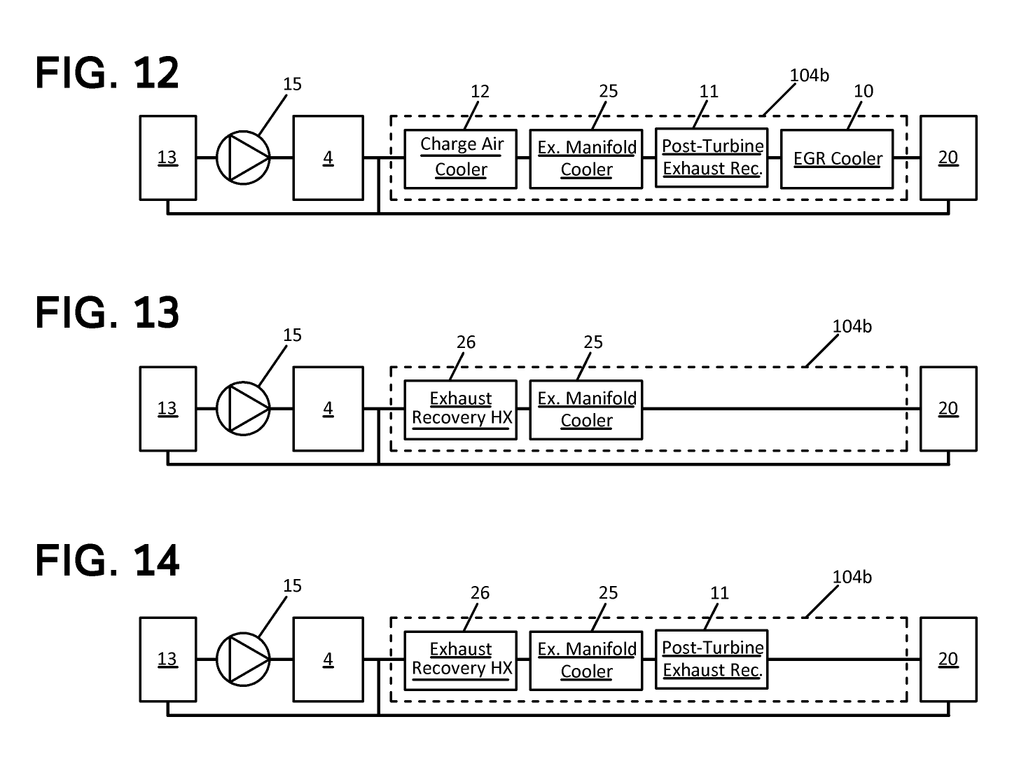

FIG. 12 illustrates Architecture 7, wherein the first heal exchanging zone 104a includes no heat exchangers, wherein the second heat exchanging zone 104b includes a charge air cooler 12, an exhaust manifold cooler 25, a post-turbine exhaust boiler 11, and an EGR cooler 10, and wherein circulation pump 15 provide all necessary system flow, including flow through the expander 20.

FIG. 13 illustrates Architecture 8, wherein the first heat exchanging zone 104a includes no heat exchangers, wherein the second heat exchanging zone 104b includes an exhaust recovery heat exchanger 26 and an exhaust manifold cooler 25, and wherein circulation pump 15 provide all necessary system flow, including flow through the expander 20.

FIG. 14 illustrates Architecture 9, wherein the first heat exchanging zone 104a includes no heat exchangers, wherein the second heat exchanging zone 104b includes an exhaust recovery heat exchanger 26, an exhaust manifold cooler 25, and a post-turbine exhaust boiler 11, and wherein circulation pump 15 provide all necessary system flow, including flow through the expander 20.

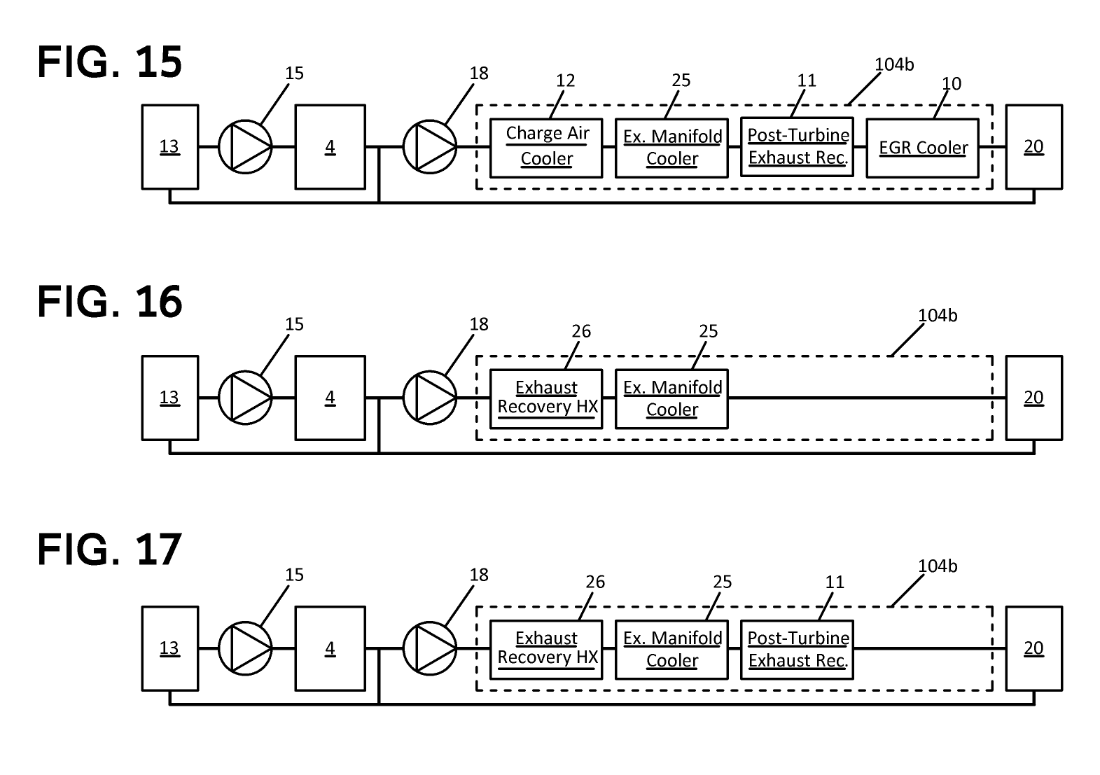

FIG. 15 illustrates Architecture 10, wherein the first heat exchanging zone 104a includes no heat exchangers, wherein the second heat exchanging zone 104b includes a charge air cooler 12, an exhaust manifold cooler 25, a post-turbine exhaust boiler 11, and an EGR cooler 10, and wherein circulation pump 18 is provided to circulate coolant through the second heat exchanging zone 104b and the expander 20.

FIG. 16 illustrates Architecture 11, wherein the first heat exchanging zone 104a includes no heat exchangers, wherein the second heat exchanging zone 104b includes an exhaust recovery heat exchanger 26 and an exhaust manifold cooler 25, and wherein circulation pump 18 is provided to circulate coolant through the second heat exchanging zone 104b and the expander 20.

FIG. 17 illustrates Architecture 12, wherein the first heat exchanging zone 104a includes no heat exchangers, wherein the second heat exchanging zone 104b includes an exhaust recovery heat exchanger 26, an exhaust manifold cooler 25, and a post-turbine exhaust boiler 11, and wherein circulation pump 18 is provided to circulate coolant through the second heat exchanging zone 104b and the expander 20.

### OPERATIONAL EXAMPLES

Not only can the system shown in FIG. 5 be configured in the variously above described architectures, each of these system architectures may also be operated in a number of configurations with varying levels of energy recovery and efficiency. As described in the following paragraphs, several architectures have been predictively modeled and evaluated in various operational configurations. These predictive models were developed to verify that the useful work generated by the expansion device 20 exceeds the parasitic losses, and to also ensure and demonstrate that the disclosed systems have a proper energy balance, and thus respect Carnot cycle principles and do not violate the second law of thermodynamics. In all of the evaluations, a power plant 4 was selected having: a power output of 227 kilowatts (kW); a coolant mass flow rate of 12 kilograms per second (kg/s); a coolant entering temperature of 88 degrees Celsius (° C.); a coolant leaving temperature of 92.5° C.; and a coolant that is 100% water. Additionally, the predictive models are based on a power plant 4 using a heavy-duty diesel fuel. However, the models and disclosed systems are entirely scalable for use with any other type of fuel, for example light-duty diesel fuel and light duty gasoline. Additionally, the models utilize an efficiency of 60% for an expansion device that is a Roots-type expander and an efficiency of 50% for the circulation pumps 15 and 18.

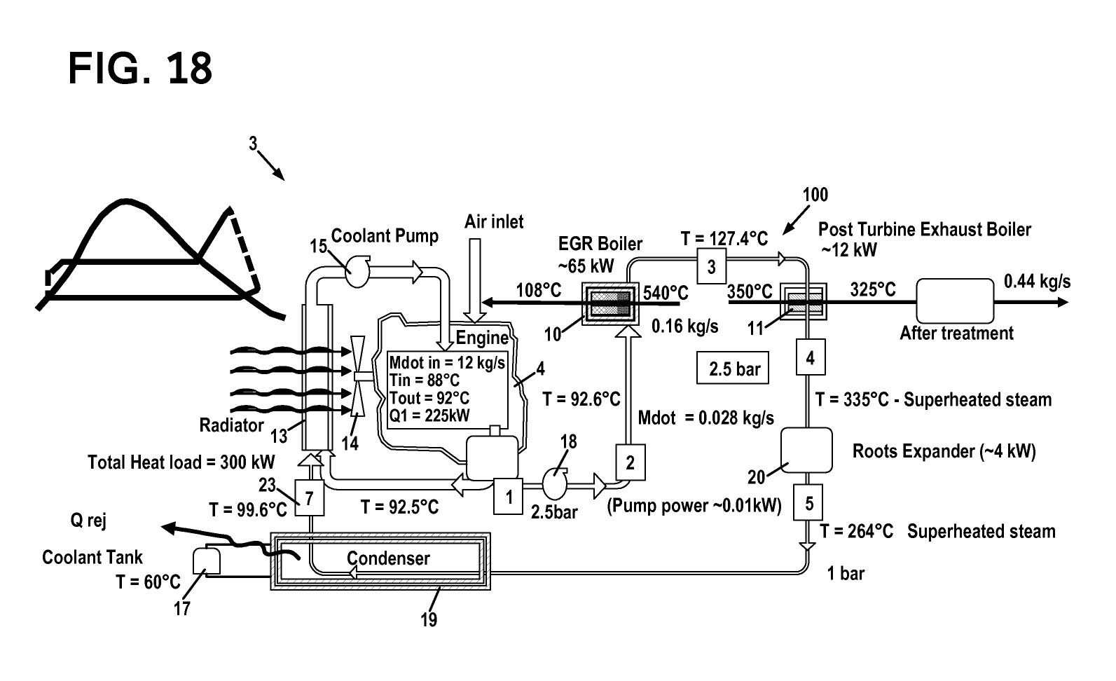

In a first operational configuration of Architecture 13, and further detailed at FIG. 18, the WHRC 100 includes coolant passing through each of the power plant 4, EGR cooler 10, and the post-turbine boiler 11. As modeled, the circulation pump 18 is configured to generate a coolant pressure increase of about 2.5 bar and a coolant mass flow rate of about 0.028 kg/s. After passing through the pump 18, the temperature of the coolant is raised by a small amount up to about 92.6° C. In a next step, the coolant is passed through the EGR cooler 10, wherein the temperature of the coolant is further increased up to about 127.4° C. The coolant is then passed through the post-turbine boiler 11, wherein the temperature of the coolant is converted to superheated steam at 335° C. Simultaneously, about 0.15 kg/s of exhaust passing through the EGR cooler is brought from about 540° C. down to about 108° C. before entering back into the power plant 4 while about 0.48 kg/s of exhaust passing through the post-turbine boiler 11 is brought from about 350° C. to about 325° C. As the coolant passes through the Roots-type expander 20, the coolant temperature is reduced down to about 264° C. at about 1 bar of pressure. This action generates about 4 kW at the shaft 21 of the expander, which can be delivered back to the power plant 4, as discussed previously. With the coolant still in a superheated state, the coolant is delivered to the condenser 19, where the coolant is reduced to a temperature of about 99.6° C. and fully condensed. As described above, the coolant can then be recombined with the coolant that has not been directed through the WHRC 100 and delivered to the radiator 13 such that the pump 15 can deliver all of the coolant back to the power plant 4 for completion of the cycle. Total pumping power for this configuration is about 0.01 kW.

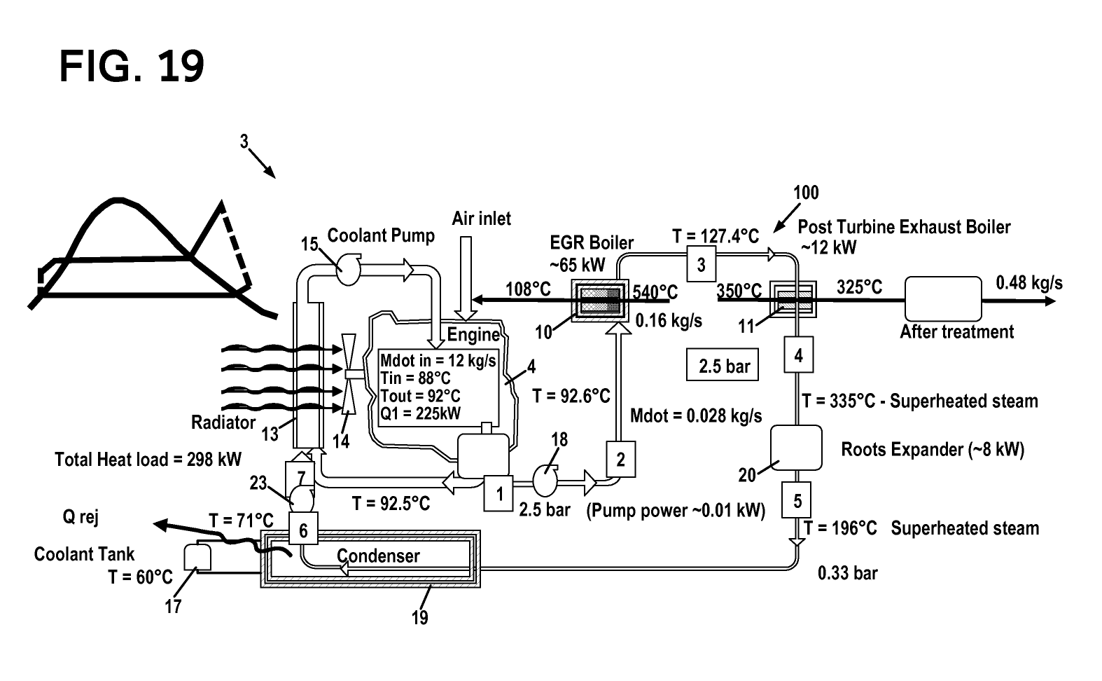

In a second operational configuration of Architecture 13, and further detailed at FIG. 19, the WHRC 100 includes coolant passing through each of the power plant 4, EGR cooler 10, and the post-turbine boiler 11. In this configuration, circulation pump 18 is provided. As modeled, the circulation pump 18 is configured to generate a coolant pressure increase of about 2.5 bar and a coolant mass flow rate of about 0.028 kg/s. After passing through the pump 18, the temperature of the coolant is raised by a small amount up to about 92.6° C. In a next step, the coolant is passed through the EGR cooler 10, wherein the temperature of the coolant is further increased up to about 127.4° C. The coolant is then passed through the post-turbine boiler 11, wherein the temperature of the coolant is converted to superheated steam at 335° C. Simultaneously, about 0.15 kg/s of exhaust passing through the EGR cooler is brought from about 540° C. down to about 108° C. before entering back into the power plant 4 while about 0.48 kg/s of exhaust passing through the post-turbine boiler 11 is brought from about 350° C. to about 325° C. As the coolant passes through the Roots-type expander 20, the coolant temperature is reduced down to about 196° C. at about 0.33 bar of pressure. This action generates about 8 kW at the shaft 21 of the expander, which can be delivered back to the power plant 4, as discussed previously. With the coolant still in a superheated state, the coolant is delivered to the condenser 19, where the coolant is reduced to a temperature of about 71° C. and fully condensed. In this configuration, and in contrast to the first operational configuration, pump 23 is provided to deliver the coolant from the condenser 19 such that the coolant can be recombined with the coolant that has not been directed through the WHRC 100 and delivered to the radiator 13, wherein the pump 15 can deliver all of the coolant back to the power plant 4 for completion of the cycle. Total pumping power for this configuration is about 0.01 kW.

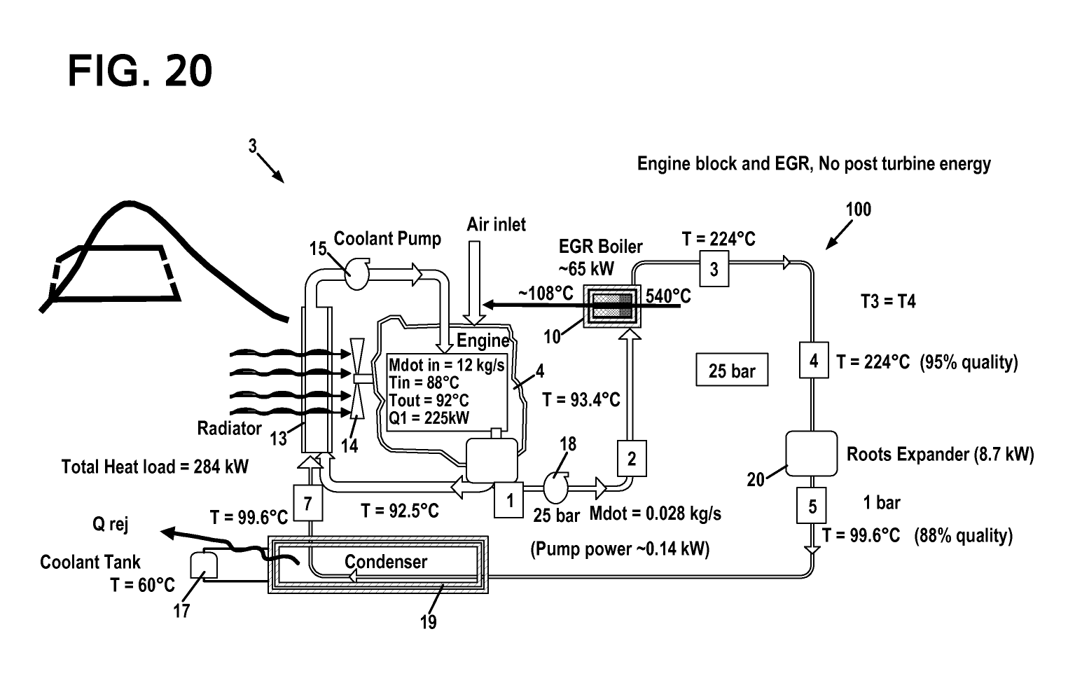

In an operational configuration of Architecture 14, and further detailed at FIG. 20, the WHRC 100 includes coolant passing through each of the power plant 4 and the EGR cooler 10. As modeled, the circulation pump 18 is configured to generate a coolant pressure increase of about 25 bar and a coolant mass flow rate of about 0.028 kg/s. After passing through the pump 18, the temperature of the coolant is raised by a small amount up to about 93.4° C. In a next step, the coolant is passed through the EGR cooler 10, wherein the temperature of the coolant is further increased up to about 224° C. at a vapor quality of about 95%. Simultaneously, about 0.15 kg/s of exhaust passing through the EGR cooler is brought from about 540° C. down to about 108° C. before entering back into the power plant 4. As the coolant passes through the Roots-type expander 20, the coolant temperature is reduced down to about 99.6° C. at about 1 bar of pressure and at a vapor quality of about 88%. This action generates about 8.7 kW at the shaft 21 of the expander, which can be delivered back to the power plant 4, as discussed previously. The coolant is then delivered to the condenser 19, where the coolant is fully condensed to a saturated liquid. As described above, the coolant can then be recombined with the coolant that has not been directed through the WHRC 100 and delivered to the radiator 13 such that the pump 15 can deliver all of the coolant back to the power plant 4 for completion of the cycle. Total pumping power for this configuration is about 0.14 kW.

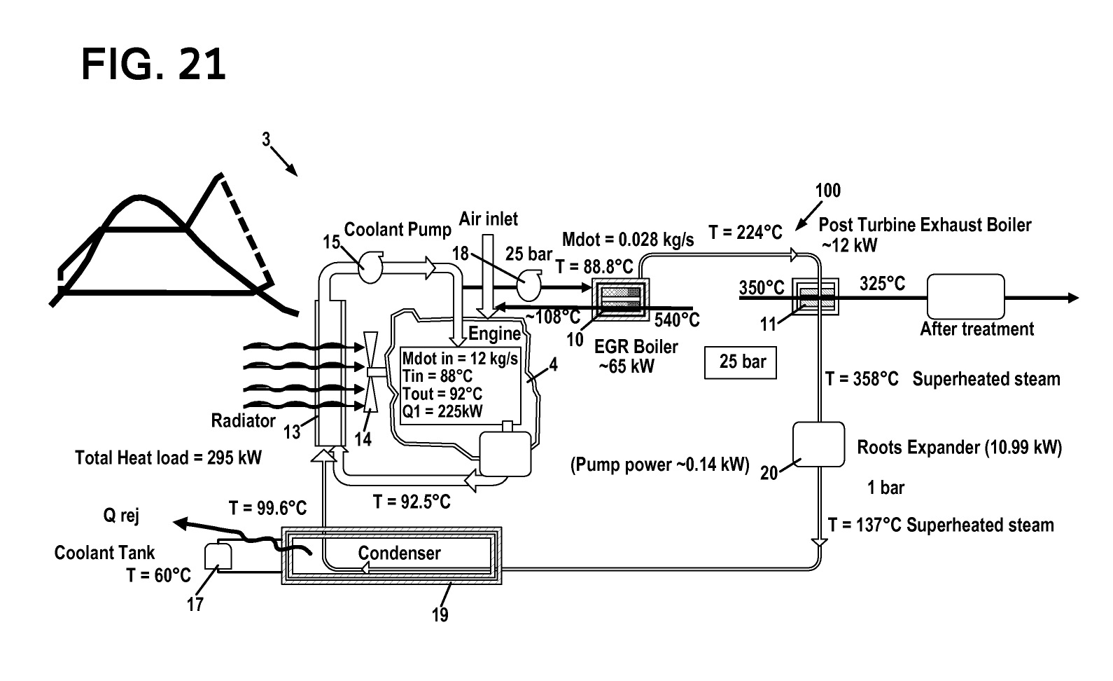

In a first operational configuration of Architecture 15, and further detailed at FIG. 21, the WHRC 100 includes coolant passing through each of the EGR cooler 10 and the post-turbine boiler 11 without first passing through the power plant 4. As modeled, the circulation pump 18 is configured to generate a coolant pressure increase of about 25 bar and a coolant mass flow rate of about 0.028 kg/s. After passing through the pump 18, the temperature of the coolant is raised by a small amount up to about 88.8° C. In a next step, the coolant is passed through the EGR cooler 10, wherein the temperature of the coolant is further increased up to about 224° C. The coolant is then passed through the post-turbine boiler 11, wherein the temperature of the coolant is converted to superheated steam at about 358° C. Simultaneously, about 0.15 kg/s of exhaust passing through the EGR cooler is brought from about 540° C. down to about 108° C. before entering back into the power plant 4 while about 0.48 kg/s of exhaust passing through the post-turbine boiler 11 is brought from about 350° C. to about 325° C. As the coolant passes through the Roots-type expander 20, the coolant temperature is reduced down to about 137° C. at about 1 bar of pressure. This action generates about 11 kW at the shaft 21 of the expander, which can be delivered back to the power plant 4, as discussed previously. With the coolant still in a superheated state, the coolant is delivered to the condenser 19, where the coolant is fully condensed and reduced to a temperature of about 99.6° C. As described above, the coolant can then be recombined with the coolant that has not been directed through the WHRC 100 and delivered to the radiator 13 such that the pump 15 can deliver all of the coolant back to the power plant 4 for completion of the cycle. Total pumping power for this configuration is about 0.14 kW.

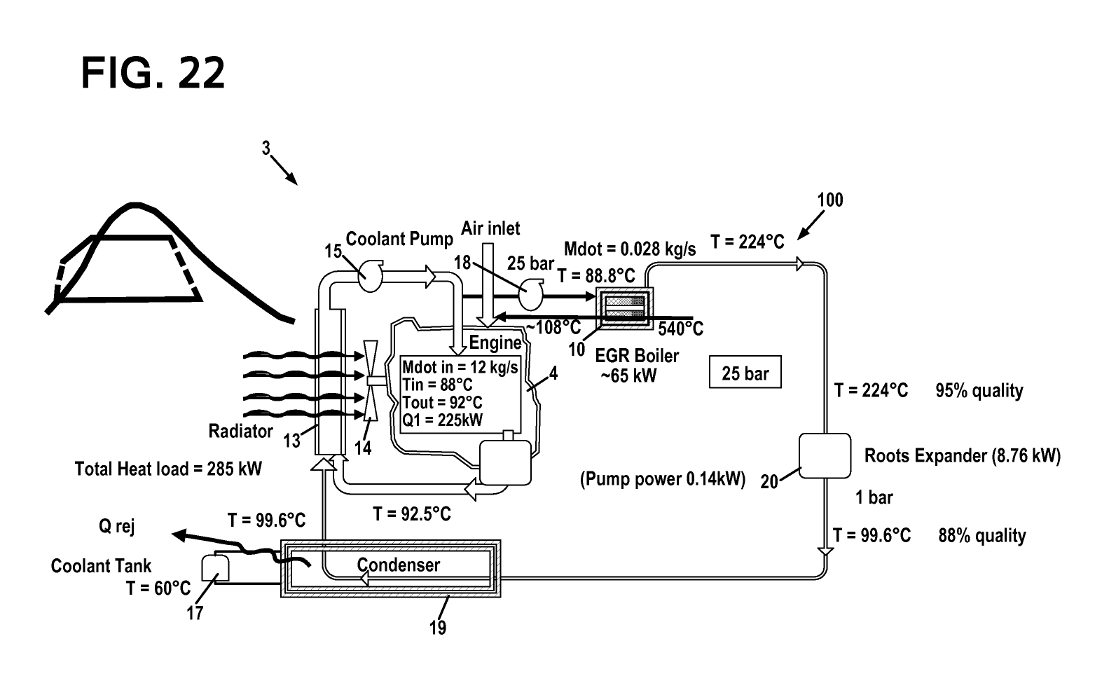

In a first operational configuration Architecture 16, and further detailed at FIG. 22, the WHRC 100 includes coolant passing through the EGR cooler 10 without first passing through the power plant 4. In this configuration, the post-turbine boiler 11 and the circulation pump 18 are not provided. As modeled, the circulation pump 18 is configured to generate a coolant pressure increase of about 25 bar and a coolant mass flow rate of about 0.028 kg/s. After passing through the pump 18, the temperature of the coolant is raised by a small amount up to about 88.8° C. In a next step, the coolant is passed through the EGR cooler 10, wherein the temperature of the coolant is further increased up to about 224° C. at a vapor quality of about 95%. Simultaneously, about 0.15 kg/s of exhaust passing through the EGR cooler is brought from about 540° C. down to about 108° C. before entering back into the power plant 4. As the coolant passes through the Roots-type expander 20, the coolant temperature is reduced down to about 99.6° C. at about 1 bar of pressure and at a vapor quality of about 88%. This action generates about 8.7 kW at the shaft 21 of the expander, which can be delivered back to the power plant 4, as discussed previously. The coolant is then delivered to the condenser 19, where the coolant is fully condensed to a saturated liquid. As described above, the coolant can then be recombined with the coolant that has not been directed through the WHRC 100 and delivered to the radiator 13 such that the pump 15 can deliver all of the coolant back to the power plant 4 for completion of the cycle. Total pumping power for this configuration is about 0.14 kW.

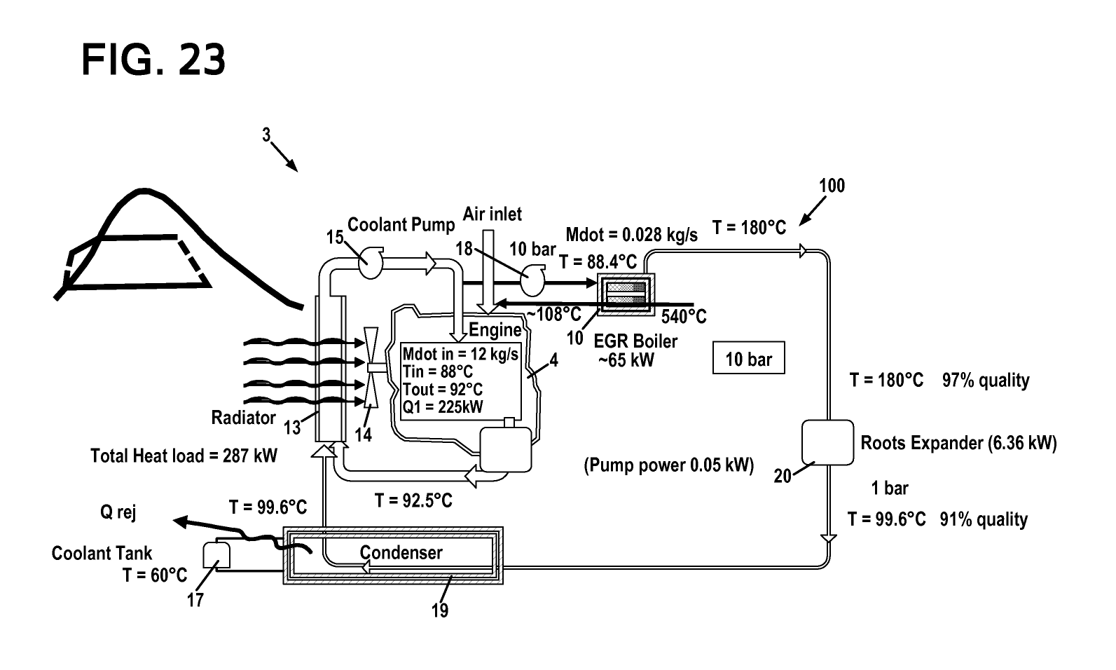

In a second operational configuration of Architecture 16, and further detailed at FIG. 23. the WHRC 100 includes coolant passing through the EGR cooler 10 without first passing through the power plant 4. In this configuration, the post-turbine boiler 11 and the circulation pump 18 are not provided. As modeled, the circulation pump 18 is configured to generate a coolant pressure increase of about 10 bar and a coolant mass flow rate of about 0.028 kg/s. After passing through the pump 18, the temperature of the coolant is raised by a small amount up to about 88.4° C. In a next step, the coolant is passed through the EGR cooler 10, wherein the temperature of the coolant is further increased up to about 180° C. at a vapor quality of about 97%. Simultaneously, about 0.15 kg/s of exhaust passing through the EGR cooler is brought from about 540° C. down to about 108° C. before entering back into the power plant 4. As the coolant passes through the Roots-type expander 20, the coolant temperature is reduced down to about 99.6° C. at about 1 bar of pressure and at a vapor quality of about 91%. This action generates about 6.4 kW at the shaft 21 of the expander, which can be delivered back to the power plant 4, as discussed previously. The coolant is then delivered to the condenser 19, where the coolant is fully condensed to a saturated liquid. As described above, the coolant can then be recombined with the coolant that has not been directed through the WHRC 100 and delivered to the radiator 13 such that the pump 15 can deliver all of the coolant back to the power plant 4 for completion of the cycle. Total pumping power for this configuration is about 0.05 kW.

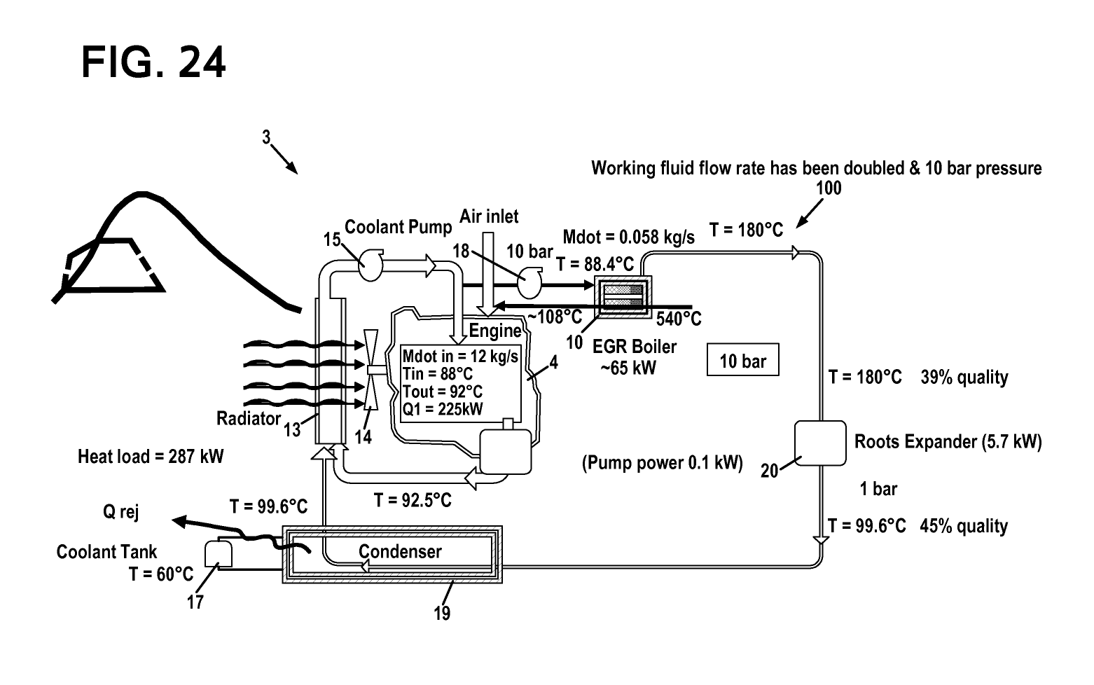

In a third operational configuration of Architecture 16, and further detailed at FIG. 24, the WHRC 100 includes coolant passing through the EGR cooler 10 without first passing through the power plant 4. In this configuration, the post-turbine boiler 11 and the circulation pump 18 are not provided. As modeled, the circulation pump 18 is configured to generate a coolant pressure increase of about 10 bar and a coolant mass flow rate of about 0.056 kg/s (i.e. about double of the previously described configurations). After passing through the pump 18, the temperature of the coolant is raised by a small amount up to about 88.4° C. In a next step, the coolant is passed through the EGR cooler 10, wherein the temperature of the coolant is further increased up to about 180° C. at a vapor quality of about 39%. Simultaneously, about 0.15 kg/s of exhaust passing through the EGR cooler is brought from about 540° C. down to about 108° C. before entering back into the power plant 4. As the coolant passes through the Roots-type expander 20, the coolant temperature is reduced down to about 99.6° C. at about 1 bar of pressure and at a vapor quality of about 45%. This action generates about 5.7 kW at the shaft 21 of the expander, which can be delivered back to the power plant 4, as discussed previously. The coolant is then delivered to the condenser 19, where the coolant is fully condensed to a saturated liquid. As described above, the coolant can then be recombined with the coolant that has not been directed through the WHRC 100 and delivered to the radiator 13 such that the pump 15 can deliver all of the coolant back to the power plant 4 for completion of the cycle. Total pumping power for this configuration is about 0.1 kW.

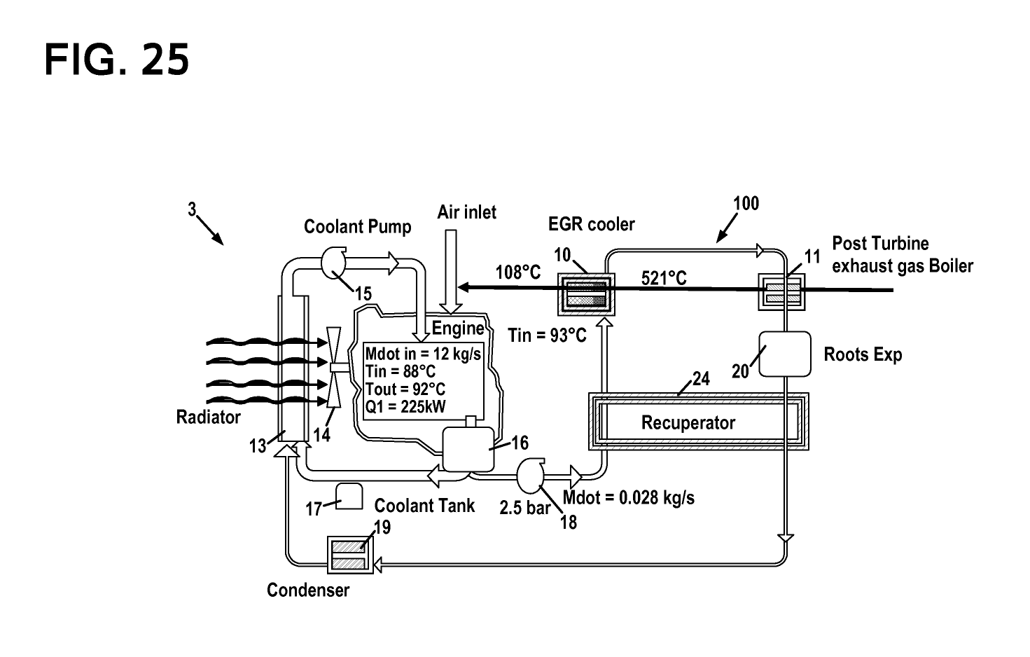

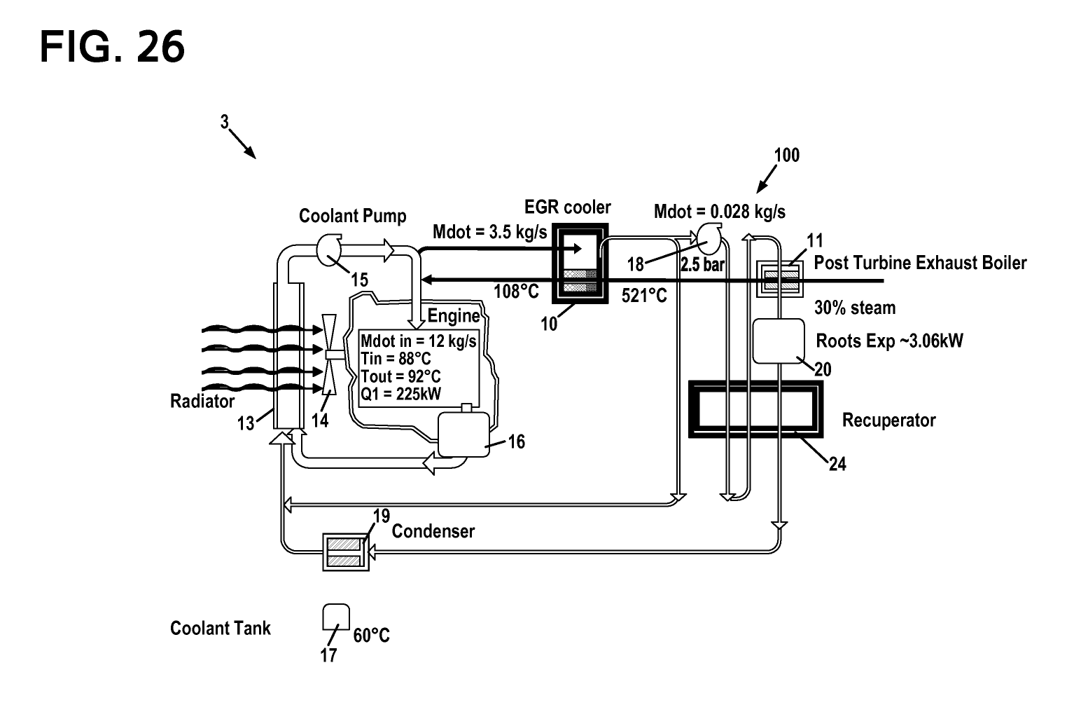

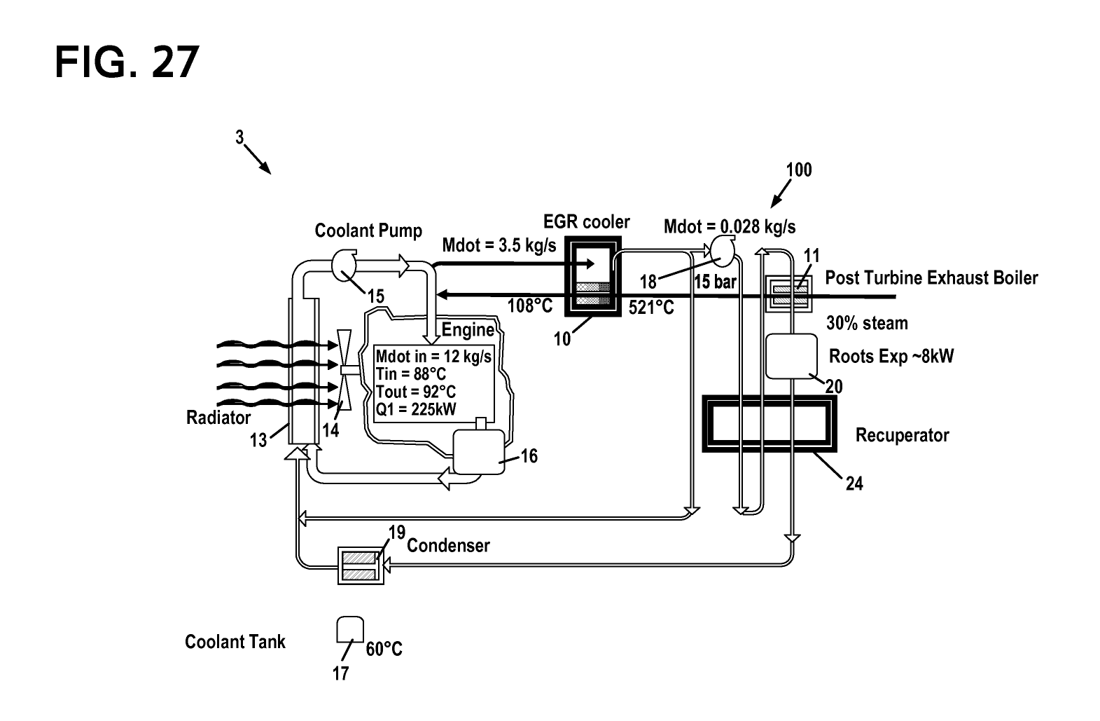

In the operational configurations shown in FIGS. 25-27, a recuperator 24 is utilized such that heat is removed from the coolant leaving the expander 20 and maintained within the WHRC 100 rather than being lost to the condenser 19 or radiator 13. FIG. 25, shows an operational configuration of Architecture 17 in which the recuperator 24 is used to preheat the coolant entering the EGR cooler 10 while FIGS. 26-27 show operational configurations of Architecture 18 in which the recuperator is used to preheat the coolant entering the post-turbine exhaust boiler 11. A pressure of 2.5 bar and mass flow rate of 0.028 kg/s is generated by the circulation pump 18 in FIGS. 25 and 26 while a pressure of 15 bar and a mass flow rate of 0.028 kg/s is generated by the circulation pump 18 in FIG. 27.

The performance characteristics of the above described operational configurations are summarized in Table 2 below:

TABLE 2

| | | WHRC 100 | | | | |
|---|---|---|---|---|---|---|
| | | | Mass | | | Total |
| | | | Flow | Coolant | Net | Engine |
| | Operational | | Rate | Pressure | Power | Heat |
| Architecture | Configuration | Heat Sources | (kg/s) | (bar) | (kW) | Load (kW) |
| Baseline | Baseline | No WHRC 100 (total engine coolant | | | | 294 |
| | | mass flow rate is 15.5 kg/s) | | | | |
| Architecture | FIG. 18 | Power plant 4 | 0.028 | 2.5 | 4 | 302 |
| 13 | (superheated) | EGR Cooler | | | | |
| | | 10 | | | | |
| | | PTE Boiler | | | | |
| | | 11 | | | | |
| Architecture | FIG. 19 | Power plant 4 | 0.028 | 2.5 | 8 | 298 |
| 13 | (superheated) | EGR Cooler | | | | |
| | | 10 | | | | |
| | | PTE Boiler | | | | |
| | | 11 | | | | |
| Architecture | FIG. 20 | Power plant 4 | 0.028 | 25 | 8.7 | 287.3 |
| 14 | (mixed | EGR Cooler | | | | |
| | phase) | 10 | | | | |
| Architecture | FIG. 21 | EGR Cooler | 0.028 | 25 | 10.9 | 295.1 |
| 15 | (superheated) | 10 | | | | |
| | | PTE Boiler | | | | |
| | | 11 | | | | |
| Architecture | FIG. 22 | EGR Cooler | 0.028 | 25 | 8.6 | 285.4 |
| 16 | (mixed | 10 | | | | |
| | phase) | | | | | |
| Architecture | FIG. 23 | EGR Cooler | 0.028 | 10 | 6.3 | 287.7 |
| 16 | (mixed | 10 | | | | |
| | phase) | | | | | |
| Architecture | FIG. 24 | EGR Cooler | 0.056 | 10 | 5.6 | 288.4 |
| 16 | (mixed | 10 | | | | |
| | phase) | | | | | |
| Architecture | FIG. 25 | Power plant 4 | 0.028 | 2.5 | ~4 | — |
| 17 | | Recuperator | | | | |
| | | 24 | | | | |
| | | EGR Cooler | | | | |
| | | 10 | | | | |
| | | PTE Boiler | | | | |
| | | 11 | | | | |
| Architecture | FIG. 26 | EGR Cooler | 0.028 | 2.5 | ~3 | — |
| 18 | (mixed | 10 | | | | |
| | phase) | Recuperator | | | | |
| | | 24 | | | | |
| | | PTE Boiler | | | | |
| | | 11 | | | | |
| Architecture | FIG. 27 | EGR Cooler | 0.028 | 15 | ~8 | — |
| 18 | (mixed | 10 | | | | |
| | phase) | Recuperator | | | | |
| | | 74 | | | | |
| | | PTE Boiler | | | | |
| | | 11 | | | | |

With respect to the “Baseline” architecture noted in Table 2, it is noted that this configuration is simply a standard power plant 4 with an EGR cooler 10 that does not include the use of a WHRC 100. All of the other configurations are modeled using the same power plant and EGR cooler as the baseline configuration, which has an associated heat load of 292 kW. It is also noted that the highest net power results are generally associated for WHRC 100 configurations implementing higher coolant pressures. For example, the highest net power calculated was the result of utilizing a superheated coolant entering the expander 20 at a pressure of 25 bar, as illustrated at FIG. 7. Calculations shown that a net power of about 8 kW produced by the WHRC 100 results in about a 4% increase in fuel economy, when assessed at a B50 condition (i.e. engine operating at 1600 RPM at 224 kW) with 30% exhaust gas recirculation.

It is also noted that creating a superheated coolant in the WHRC 100 also functions to increase the engine heat load (see configurations of FIGS. 4, 5, and 7). However, it is observed that the presented WHRC 100 configurations presented herein do not significantly adversely affect the total engine heat load, particularly in comparison to the net power produced. In some examples, the heat load is actually reduced. Where an increase does occur, some of the additional heat from the WHRC 100 can be rejected to the coolant tank 17, which can have an initial temperature of about 60° C. Any additional heating load generated by the WHRC 100 can also be easily handled by a modest increase in operation of the power plant cooling fan 14.

As the disclosed WHRC 100 utilizes the existing engine coolant as the working fluid, the need to provide a separate working fluid circuit in the system is entirely eliminated. This feature allows the WHRC 100 to be easily added to existing power plan designs. As the WHRC 100 works in cooperation with a standard power plant 4, the resulting system is able to operate at a low speed which minimizes costs and maximizes reliability with respect to coupling the WHRC 100 to the power plant drivetrain. Additionally, a Roots-type expander 20 is robust to liquid and can be expected to operate reliably. Furthermore, by using the existing engine coolant, the WHRC 100 will have no unexpected freeze issues since the WHRC 100 is entirely compatible with coolant antifreeze strategies used in internal combustion engines.

In comparison to steam based and other types of systems which pressurize working fluids up to and well beyond pressures of 100 bar, the disclosed WHRC 100 operates as a relatively low pressure system which minimizes costs and maximizes reliability. As importantly, low operating pressures enable a number of operational options for the WHRC 100. For example, the low operating pressures allow for the safer use of ethanol as a coolant, alone or in a mixture of water. Low operating pressures also allow for the controlled boiling of glycol based coolants such that degradation of the glycol is avoided, which would be unavoidable in high pressure/temperature applications. Additionally, low operating pressures allow a coolant mixture of glycol and water to be boiled such that a portion of the glycol remains as a liquid. The liquid glycol can act as a highly effective sealant between the expander housing and the rotors disposed therein which increases operational efficiency of the expander 20. Yet another benefit of low pressure operation is that the parasitic losses associated with the circulation pumps can be minimized.

Although multiple architectures and operational configurations are presented herein, it is noted that the concepts disclosed herein are not limited to only the disclosed architectures and configurations. Rather, the concept of utilizing the coolant as a working fluid with a Roots-type expander, or another type of energy extraction device, may be implemented in a wide variety of additional approaches. Additionally, the implementation of the disclosed WHRC 100 system does not require the power plant 4 to be specifically designed or redesigned to accommodate the WHRC 100. However, the disclosure is not limited only to such an application and it is fully contemplated in the disclosure that a power plant 4 could be designed to operate optimally with the disclosed WHRC 100. For example, the operating conditions of the power plant 4 (e.g. EGR cooler leaving exhaust temperature and the power plant coolant inlet temperature) could be treated as open variables in the design of the power plant 4, rather than as the fixed values used in the models above. Additionally, other types of equipment could be used for heat transfer to the working fluid or coolant, such as specialized cooling jackets.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the disclosure.

What is claimed is:

1. A power generation system including:
a. an internal combustion engine having a crankshaft;
b. a coolant circuit extending through the internal combustion engine, the coolant circuit including a radiator and a coolant pump configured to circulate the coolant between the internal combustion engine and the radiator;
c. a waste heat recovery circuit including:
i. a Roots-type fluid expander being configured to generate power at an output shaft by expanding a portion of the coolant and being configured to deliver the power back to the internal combustion engine crankshaft via the output shaft;
ii. a circulation pump configured to circulate the portion of the coolant between the Roots-type expander and the coolant circuit; and
iii. a condenser configured to condense the portion of the coolant leaving the Roots-type fluid expander at least down to a saturated liquid.

2. The power generation system of claim 1, wherein the waste heat recovery circuit is configured such that the circulation pump draws the portion of the coolant after the portion of the coolant has first passed through the internal combustion engine and returns the portion of the coolant at a location upstream of the radiator.

3. The power generation system of claim 2, further including an EGR cooler located within the waste heat recovery circuit, wherein the EGR cooler is located between the circulation pump and the Roots-type fluid expander.

4. The power generation system of claim 3, further including a post-turbine recovery system located within the waste heat recovery circuit, wherein the post-turbine recovery system is located between the EGR cooler and the Roots-type fluid expander.

5. The power generation system of claim 4, wherein the waste heat recovery circuit is configured such that the Roots-type expander expands the portion of working fluid from a first superheated state to a second superheated state at a lower temperature.

6. The power generation system of claim 5, wherein the circulation pump pressurizes the portion of the coolant to a pressure of about 2.5 bar.

7. The power generation system of claim 5, further including a second circulation pump located in the waste heat recovery circuit between the condenser and the radiator.

8. The power generation system of claim 3, wherein the waste heat recovery circuit is configured such that the Roots-type expander expands the portion of working fluid from a first mixed-phase state to a second mixed-phase state at a lower temperature.

9. The power generation system of claim 1, wherein the waste heat recovery circuit is configured such that the circulation pump draws the portion of the coolant before the portion of the coolant has first passed through the internal combustion engine and returns the portion of the coolant at a location upstream of the radiator.

10. The power generation system of claim 9, further including an EGR cooler located within the waste heat recovery circuit, wherein the EGR cooler is located between the circulation pump and the Roots-type fluid expander.

11. The power generation system of claim 10, further including a post-turbine recovery system located within the waste heat recovery circuit, wherein the post-turbine recovery system is located between the EGR cooler and the Roots-type fluid expander.

12. The power generation system of claim 11, wherein the waste heat recovery circuit is configured such that the Roots-type expander expands the portion of working fluid from a first superheated state to a second superheated state at a lower temperature.

13. The power generation system of claim 12, wherein the circulation pump pressurizes the portion of the coolant to a pressure of about 25 bar.

14. The power generation system of claim 10, wherein the waste heat recovery circuit is configured such that the Roots-type expander expands the portion of working fluid from a first mixed-phase state to a second mixed-phase state at a lower temperature.

15. The power generation system of claim 14, wherein the circulation pump pressurizes the portion of the coolant to a pressure of about 10 bar.

16. The power generation system of claim 14, wherein the circulation pump pressurizes the portion of the coolant to a pressure of about 25 bar.

17. The power generation system of claim 1, wherein the waste heat recovery circuit further includes a recuperator to transfer heat from the portion of coolant leaving the Roots-type expander to the portion of coolant leaving the circulation pump.

18. A method of recovering waste heat from a power plant comprising:
a. providing a liquid cooled power plant having a crankshaft;
b. pumping a coolant with a fluid pump through a coolant circuit including the power plant;
c. drawing a portion of the coolant from coolant circuit;
d. heating the portion of the coolant with heat generated by the power plant;
e. expanding the portion of the coolant with an expansion device such that power is generated at an output shaft of the expansion device;
f. delivering the power developed at the expansion device output shaft to the internal combustion engine crankshaft;
g. condensing the coolant to at least a saturated liquid state; and
h. returning the portion of the coolant to the coolant circuit,

19. The method of recovering waste heat from a power plant of claim 18, wherein the step of drawing a portion of the coolant from the coolant circuit includes drawing the portion of the coolant at a location downstream of the power plant.

20. The method of recovering waste heat from a power plant of claim 18, wherein the step of drawing a portion of the coolant from the coolant circuit includes drawing the portion of the coolant at a location upstream of the power plant.

21. The method of recovering waste heat from a power plant of claim 18, wherein the step of heating the portion of the coolant with heat generated by the power plant includes heating the portion of the coolant with one or more of: radiation heat from the power plant, an EGR cooler receiving an exhaust stream from the power plant, and a post-turbine exhaust boiler receiving an exhaust stream from the power plant.

22. The method of recovering waste heat from a power plant of claim 18, wherein the expansion device is a Roots-type expander.

23. A power generation system including:
a. an internal combustion engine having a crankshaft;
b. a coolant circuit extending through the internal combustion engine, the coolant circuit including a radiator and a coolant pump configured to circulate the coolant between the internal combustion engine and the radiator;
c. a waste heat recovery circuit including a fluid expansion device being configured to generate power at an output shaft by expanding a portion of the coolant from the coolant circuit and being configured to deliver the power back to the internal combustion engine via the output shaft; and
d. a heat exchanger to heat the portion of coolant upstream of the expansion device.

24. The power generation system of claim 23, whereinthe expansion device is a Roots-type expander.

25. The power generation system of claim 23, wherein the portion of the coolant from the coolant circuit is drawn from the coolant circuit upstream of the internal combustion engine and is returned to the coolant circuit downstream of the internal combustion engine.

26. The power generation system of claim 23, wherein the portion of the coolant from the coolant circuit is drawn and returned from the coolant circuit downstream of the internal combustion engine.

27. The power generation system of claim 26, further including a circulation pump to circulate the coolant between the expansion device and the coolant circuit.

28. The power generation system of claim 23, wherein the heat exchanger includes one or more of an exhaust gas recirculation cooler, a charge air cooler, a post-turbine exhaust boiler, a recuperator, an exhaust manifold cooler, and an exhaust gas heat exchanger.
